(19) United States
(12) Patent Application Publication
(10) Pub. No.: US 2026/0370686 A1
(43) Pub. Date: Nov. 19, 2026

(54) IN-VEHICLE DEVICE, SERVER COMPUTER, COMMUNICATION SYSTEM, CONTROL METHOD AND COMPUTER PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventors: Kenta KURIYAMA, Osaka-shi (JP); Akihiro OGAWA, Osaka-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 19/153,823

(22) PCT Filed: Feb. 6, 2023
(86) PCT No.: PCT/JP2023/003740

§ 371 Date: Aug. 5, 2025

(51) Int. Cl. H04L 9/40; H04W 4/40; H04W 12/08; H04W 12/63

(52) U.S. Cl. CPC H04L 63/20; H04W 4/40; H04W 12/08; H04W 12/63

(57) ABSTRACT

An in-vehicle device configured to be installed in a vehicle, the in-vehicle device including: a processor that is configured to cause a communication unit that communicates with an external device located outside the vehicle to restrict communication with the external device, in accordance with a security rule generated based on vehicle-road information that includes vehicle information of the vehicle and roadside information which is information relating to surroundings of the vehicle, wherein the vehicle information includes at least one of application operation information that specifies an application operating in the vehicle and connection information that indicates a communication connection state with the external device.

### BACKGROUND

The present disclosure relates to an in-vehicle device, a server computer, a communication system, a control method, and a computer program.

It is known that cybersecurity attacks on computer systems and networks by malicious third parties can be countered by appropriately setting security rules (e.g., communication access permission list, communication filtering threshold value, etc.). WO 2022/009274 described below discloses a security setting assistance device that calculates predicted values of security setting parameters by machine learning using feature values of traffic data related to DDOS (Distributed Denial of Service) attacks. The security setting assistance device provides security setting assistance, based on the result of the security settings that are based on the predicted values being evaluated in advance.

### SUMMARY

An in-vehicle device according to an aspect of the present disclosure is an in-vehicle device for installation in a vehicle, the in-vehicle device causing a communication unit that communicates with an external device located outside the vehicle to restrict communication with the external device, in accordance with a security rule generated based on vehicle-road information including vehicle information of the vehicle and roadside information which is information relating to surroundings of the vehicle, the vehicle information including at least one of application operation information specifying an application operating in the vehicle and connection information indicating a communication connection state with the external device.

### BRIEF DESCRIPTION OF THE DRAWINGS

FIG. 1 is a schematic diagram showing the configuration of a communication system according to an embodiment of the present disclosure.

FIG. 2 is a block diagram showing the hardware configuration of an in-vehicle system shown in FIG. 1.

FIG. 3 is a block diagram showing the hardware configuration of a roadside device shown in FIG. 1.

FIG. 4 is a block diagram showing the hardware configuration of a server (i.e., server computer) shown in FIG. 1.

FIG. 5 is a block diagram showing the functional configuration of the in-vehicle system shown in FIG. 2.

FIG. 6 is a flowchart showing an operation relating to determination of security rules, among the operations of the in-vehicle system.

FIG. 7 is a flowchart showing an operation relating to communication, among the operations of the in-vehicle system.

FIG. 8 is a diagram showing a first example showing a change in security rules following a change in an application operation status in a vehicle.

FIG. 9 is a diagram showing the positions of vehicles.

FIG. 10 is a diagram showing a second example showing a change in security rules following a change in the application operation status in the vehicle.

FIG. 11 is a diagram showing a third example showing a change in security rules following a change in a communication connection status in the vehicle.

FIG. 12 is a diagram showing a fourth example showing a change in security rules following a change in the application operation status and the communication connection status in the vehicle.

FIG. 13 is a block diagram showing the functional configuration of an in-vehicle system according to a variation.

FIG. 14 is a diagram showing an example in which a security rule table is generated from application specifications.

### DETAILED DESCRIPTION OF EMBODIMENTS

### Technical Problem

In an in-vehicle network, application programs (e.g., user-oriented application programs; hereinafter simply “applications”) operating in a vehicle are switched. Also, out-of-vehicle communication parameters (e.g., communication amount, network information such as communication destination IP address, port number, etc.) vary according to the connection state with an out-of-vehicle device (e.g., server computer, etc.). Accordingly, to counter cybersecurity attacks, security rules need to be dynamically controlled using the limited resources of an in-vehicle device. However, with the method disclosed in WO 2022/009274, the computational cost of machine learning feature values is high (i.e., load due to computational processing is large) and many resources are required. Many resources are also required when utilizing machine learning results. Thus, difficulties are encountered in applying the method disclosed in WO 2022/009274 to an in-vehicle device with limited resources.

Accordingly, an object of the present disclosure is to provide an in-vehicle device, a server computer, a communication system, a control method, and a computer program that are able to determine security rules with a low computational cost and dynamically control the security rules according to at least one of the operation status of applications in a vehicle in which the in-vehicle device is installed and the connection state with out-of-vehicle devices.

### Advantageous Effects of Disclosure

According to the present disclosure, an in-vehicle device, a server computer, a communication system, a control method, and a computer program that are able to determine security rules with a low computational cost and dynamically control the security rules according to at least one of the operation status of applications in a vehicle in which the in-vehicle device is installed and the connection state with out-of-vehicle devices can be provided.

### DESCRIPTION OF EMBODIMENTS OF DISCLOSURE

The contents of the embodiments of the present disclosure will now be enumerated and described. The embodiments described below may be at least partially combined in any manner.
(1) An in-vehicle device according to a first aspect of the present disclosure is an in-vehicle device installed in a vehicle, the in-vehicle device causing a communication unit that communicates with an external device located outside the vehicle to restrict communication with the external device, in accordance with a security rule generated based on vehicle-road information including vehicle information of the vehicle and roadside information which is information relating to surroundings of the vehicle, the vehicle information including at least one of application operation information specifying an application operating in the vehicle and connection information indicating a communication connection state with the external device. Security rules can thereby be determined with a low computational cost, and the security rules can be dynamically controlled according to the operation status of applications in the vehicle in which the in-vehicle device is installed and the connection state with external devices.
(2) In (1) above, the in-vehicle device is able to receive the security rule from the external device. The load due to computational processing for determining security rules in the in-vehicle device can thereby be reduced.
(3) In (1) above, the in-vehicle device may further include a roadside information acquisition unit configured to acquire the roadside information from the external device, a vehicle-road information generation unit configured to generate the vehicle-road information by adding the vehicle information to the roadside information, a determination unit configured to determine out-of-vehicle communication parameter determination information, based on the vehicle-road information, and a security rule generation unit configured to generate the security rule, based on the out-of-vehicle communication parameter determination information. Appropriate security rules can thereby be determined according to the operation status of applications in the vehicle and the connection state with external devices.
(4) In (3) above, the vehicle-road information may include at least one of position information and map information, in addition to at least one of the application operation information and the connection information. The out-of-vehicle communication parameters for generating appropriate security rules can thereby be determined.
(5) In (3) or (4) above, the out-of-vehicle communication parameter determination information may include at least one of the application operation information and the connection information. Appropriate security rules can thereby be generated.
(6) In (5) above, the out-of-vehicle communication parameter determination information may include at least the application operation information, and the security rule generation unit may generate, in a case where the application operation information specifies that there is no application operating, the security rule to include a first communication filtering threshold value, and may generate, in a case where the application operation information specifies an application that controls door opening and closing of the vehicle, the security rule to include a second communication filtering threshold value greater than the first communication filtering threshold value. If data exceeding the expected communication amount (i.e., first communication filtering threshold value) is transmitted to the in-vehicle system when the vehicle is parked and before authentication has been performed (i.e., there are no operating applications), it thereby becomes possible to filter the transmission data.

Accordingly, it becomes possible to counter DOS (Denial of Service) attacks, for example.
(7) In (5) or (6) above, the out-of-vehicle communication parameter determination information may include at least the application operation information, and the security rule generation unit may generate, in a case where the application operation information specifies that there is no application operating, the security rule to not include access permission, and may generate, in a case where the application operation information specifies that a driving assistance application is operating, the security rule to include access permission to an external device that provides a service to the driving assistance application. If there is access from an unexpected communication destination to the in-vehicle system when the vehicle is located in an area not covered by the driving assistance service (i.e., when there are no operating applications), access therefrom can thereby be restricted. For example, it becomes possible to counter access that falsifies the communication destination (i.e., spoofing).
(8) In any one of (5) to (7) above, the out-of-vehicle communication parameter determination information may include at least the connection information, the security rule generation unit may generate, in a case where a position of the vehicle specified from the vehicle-road information is within a first area including a plurality of intersections, the security rule to include a third communication filtering threshold value specified by the connection information corresponding to the first area, and may generate, in a case where the position of the vehicle specified from the vehicle-road information is within a second area smaller than the first area and including one intersection, the security rule to include a fourth communication filtering threshold value specified by the connection information corresponding to the second area, and the fourth communication filtering threshold value may be larger than the third communication filtering threshold value. If data exceeding the communication amount (i.e., third communication filtering threshold value) expected from the connection state is transmitted to the in-vehicle system when the vehicle is located in the first area (e.g., cloud communication area), it thereby becomes possible to filter the transmission data. Accordingly, it becomes possible to counter DoS attacks, for example.
(9) In (5) above, the out-of-vehicle communication parameter determination information may include the application operation information, and the security rule generation unit, in a case where the out-of-vehicle communication parameter determination information specifies that a plurality of applications are operating in the vehicle, may generate a security rule table relating to each of the plurality of applications that are operating, and generate the security rule by integrating the plurality of security rule tables. Security rules for restricting communication of one communication unit can thereby be efficiently generated.
(10) In any one of (4) to (9) above, the determination unit may, in a case where the vehicle-road information does not include the connection information, generate connection information as the out-of-vehicle communication parameter determination information from the vehicle-road information. Operation information and connection information can thereby be generated from the vehicle-road information, and appropriate security rules can be generated.
(11) In any one of (1) to (10) above, the security rule may include a restriction relating to at least one of access frequency, communication speed, number of sessions, number of SYN packets, communication address of communication destination, and port number of communication destination that relate to communication by the communication unit. The safety of communication by the communication unit can thereby be improved.
(12) In any one of (1) to (11) above, the in-vehicle device may further include an update unit configured to update the security rule, and the update unit may update the security rule in response to a new application to be operated in the vehicle or an updated application of an application operating in the vehicle being received by the communication unit. Security rules can thereby be maintained in an appropriate state.
(13) In (12) above, a new security rule corresponding to a new application or an updated application may be received from the external device, and the update unit may update the security rule, using the new security rule. The load due to computational processing for determining security rules according to the operation status of applications can thereby be further reduced.
(14) A server computer according to a second aspect of the present disclosure includes a generation unit configured to generate a security rule for restricting communication of an in-vehicle device installed in a vehicle with an external device located outside the vehicle, based on vehicle-road information including vehicle information of the vehicle and roadside information relating to surroundings of the vehicle, and a communication unit configured to transmit the security rule to the in-vehicle device, the vehicle information including at least one of application operation information specifying an application operating in the vehicle and connection information indicating a communication connection state with the external device. The in-vehicle system can thereby dynamically control out-of-vehicle communication, in accordance with security rules that depend on the operation status of applications in the vehicle and the connection state with external devices.
(15) In (14) above, the communication unit is able to receive the vehicle information from the in-vehicle device, the server computer can further include a vehicle-road information generation unit configured to generate the vehicle-road information by adding the vehicle information received by the communication unit to the roadside information, and a determination unit configured to determine out-of-vehicle communication parameter determination information, based on the vehicle-road information, and the generation unit is able to generate the security rule, based on the out-of-vehicle communication parameter determination information. The load due to computational processing for determining security rules in the in-vehicle device can thereby be reduced.
(16) A communication system according to a third aspect of the present disclosure includes the in-vehicle device according to any one of (1) to (13) above and the server computer according to (14) above, the in-vehicle device causing the server computer to communicate, as the external device, with the communication unit installed in the vehicle. The in-vehicle device is thereby able to dynamically control the security rules according to the operation status of applications in the vehicle and the connection state with external devices.
(17) A communication system according to a fourth aspect of the present disclosure includes the in-vehicle device according to (1) or (2) above and the server computer according to (15) above, the in-vehicle device causing the server computer to communicate, as the external device, with the communication unit installed in the vehicle. The in-vehicle device is thereby able to dynamically control the security rules according to the operation status of applications in the vehicle and the connection state with external devices.
(18) A control method according to a fifth aspect of the present disclosure is a control method for an in-vehicle system installed in a vehicle, including a step of an in-vehicle device included in the in-vehicle system causing a communication unit that communicates with an external device located outside the vehicle to restrict communication with the external device, in accordance with a security rule generated based on vehicle-road information including vehicle information of the vehicle and roadside information which is information relating to surroundings of the vehicle, the vehicle information including at least one of application operation information specifying an application operating in the vehicle and connection information indicating a communication connection state with the external device. The in-vehicle device is thereby able to dynamically control the security rules according to the operation status of applications in the vehicle and the connection state with external devices.
(19) A computer program according to a sixth aspect of the present disclosure is a computer program for causing a computer installed in a vehicle to realize a function of causing a communication unit that communicates with an external device located outside the vehicle to restrict communication with the external device, in accordance with a security rule generated based on vehicle-road information including vehicle information of the vehicle and roadside information which is information relating to surroundings of the vehicle, the vehicle information including at least one of application operation information specifying an application operating in the vehicle and connection information indicating a communication connection state with the external device. The in-vehicle device is thereby able to dynamically control the security rules according to the operation status of applications in the vehicle and the connection state with external devices.

### Detailed Description of Embodiments of Disclosure

In the following embodiments, components that are the same are given the same reference numerals. The names and functions of those components are also the same. Accordingly, detailed description of those components will not be repeated.

### Overall Configuration

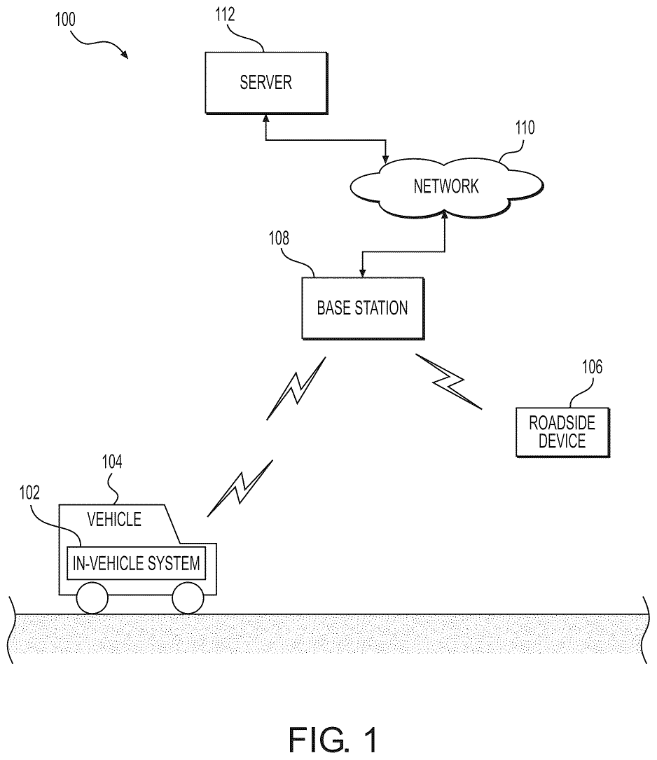

Referring to FIG. 1, a communication system 100 according to an embodiment of the present disclosure includes a vehicle 104 in which an in-vehicle system 102 is installed and a server (i.e., server computer) 112 capable of communicating with the in-vehicle system 102 via a base station 108 and a network 110. The communication system 100 may include a roadside device 106 that includes a sensor and is fixed to the roadside. The server 112 provides services such as transmitting driving assistance information to the in-vehicle system 102. Data that is utilized in generating the driving assistance information to be transmitted by the server 112 is transmitted (hereinafter, also “uploaded”) to the server 112 by the in-vehicle system 102 and the roadside device 106.

The base station 108 provides a mobile communication service via 4G (i.e., 4th generation mobile communication system) and 5G (i.e., 5th generation mobile communication system) networks, for example. The base station 108 is connected to the network 110. The in-vehicle system 102 installed in the vehicle 104 has a communication function conforming to communication specifications (i.e., 4G network, 5G network, etc.) that are supported by the base station 108. The roadside device 106 is also connected to the network 110 via the base station 108. Note that communication of the server 112 with the in-vehicle system 102 and the roadside device 106 is not limited to communication via the network 110, and may be wireless communication such as Wi-Fi. Also, communication of the server 112 with the roadside device 106 that is installed in a fixed manner may be wired communication that is not performed via the base station 108.

The sensor data acquired by sensors (hereinafter, also “in-vehicle sensors”) installed in the vehicle 104 is analyzed by the in-vehicle system 102, and the analysis results are stored as dynamic information. The dynamic information is used in an automatic driving function of the vehicle. Also, sensor data and dynamic information are uploaded from the in-vehicle system 102 to the server 112.

The roadside device 106 is installed on the roadside and acquires information on the roadside with a sensor (hereinafter, also “infrastructure sensor”). The sensor data is analyzed in the roadside device 106, and dynamic objects and the like are detected. Sensor data and analysis results are uploaded from the roadside device 106 to the server 112. The vehicle 104 shown in FIG. 1 is a detection target of the infrastructure sensor included in the roadside device 106 and is detected as a dynamic object.

Dynamic information is information relating to dynamic objects detected by the sensors (i.e., infrastructure sensor and in-vehicle sensors). Dynamic objects are not limited to moving objects (e.g., people and vehicles, etc.), and also include objects that have a movement function but are stationary. The dynamic information is used as driving assistance information for use in automatic driving of the vehicle. Also, the dynamic information is transmitted to the server 112 and is utilized in generating driving assistance information to be transmitted from the server 112 to vehicles (including vehicle 104 and vehicles other than vehicle 104).

FIG. 1 shows one base station 108, one roadside device 106, and one vehicle 104 in which the in-vehicle system 102 is installed. But this is merely an example. Usually, there are multiple base stations and multiple vehicles in which an in-vehicle system is installed. There may be vehicles in which an in-vehicle system capable of communicating with the server 112 is not installed.

Vehicles in which an in-vehicle system is not installed are detected as dynamic objects.

### Hardware Configuration of In-Vehicle System

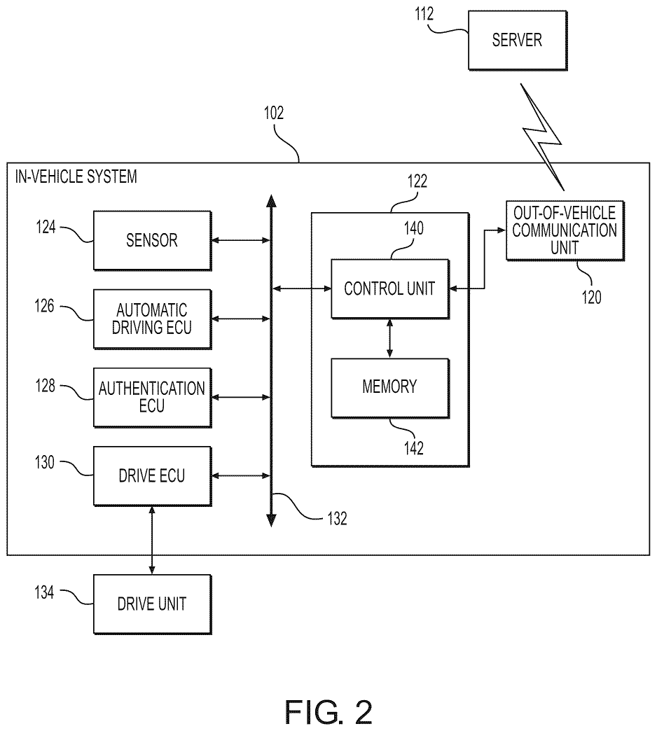

Referring to FIG. 2, an example of the hardware configuration of the in-vehicle system 102 installed in the vehicle 104 is shown. The in-vehicle system 102 includes an out-of-vehicle communication unit 120, an in-vehicle device 122, a sensor 124, an automatic driving ECU (Electronic Control Unit) 126, an authentication ECU 128, a drive ECU 130, and a bus 132. Note that the in-vehicle system 102 includes a plurality of ECUs, with the automatic driving ECU 126, the authentication ECU 128, and the drive ECU 130 being shown in FIG. 2 as an example.

The out-of-vehicle communication unit 120 performs wireless communication with an external device outside the vehicle 104 (e.g., performs communication with server 112, etc. via base station 108). The out-of-vehicle communication unit 120 includes an IC (Integrated Circuit) for performing modulation and multiplexing employed in wireless communication, an antenna for transmitting and receiving radio waves of a predetermined frequency, and an RF (Radio Frequency) circuit. The out-of-vehicle communication unit 120 also has a function of communicating with a GNSS (Global Navigation Satellite System) such as GPS (Global Positioning System), in order to acquire information for specifying the current position of the vehicle 104. The out-of-vehicle communication unit 120 may also have a communication function such as Wi-Fi.

The in-vehicle device 122 includes a control unit 140 and a memory 142. The control unit 140 is constituted to include a CPU (Central Processing Unit) and controls the memory 142. The memory 142 is, for example, a rewritable non-volatile semiconductor memory, and stores computer programs (hereinafter, simply referred to as programs) to be executed by the control unit 140. The memory 142 provides a work area for programs that are executed by the control unit 140. The control unit 140 acquires data to be processed directly from the out-of-vehicle communication unit 120 and via the bus 132 from units other than the out-of-vehicle communication unit 120. The control unit 140 stores data received from the out-of-vehicle communication unit 120 and data received via the bus 132 in the memory 142 as appropriate. The control unit 140 stores processing results in the memory 142 and outputs the processing results to the bus 132.

The in-vehicle device 122 acts as a gateway (i.e., performs communication protocol conversion, etc.) between the out-of-vehicle communication function (specifically, communication specifications) and the in-vehicle communication function (i.e., communication specifications). The automatic driving ECU 126, the authentication ECU 128, and the like are able to communicate with external devices via the in-vehicle device 122 and the out-of-vehicle communication unit 120. As will be described later, the in-vehicle device 122 executes control of security rules relating to out-of-vehicle communication. Also, the in-vehicle device 122 transmits driving assistance information to the automatic driving ECU 126, out of the information received from outside via the out-of-vehicle communication unit 120, for example. The bus 132 performs a communication function within the in-vehicle system. The in-vehicle device 122, the sensor 124, the automatic driving ECU 126, the authentication ECU 128, and the drive ECU 130 communicate (i.e., exchange data) with each other via the bus 132. CAN (Controller Area Network), for example, is used for the bus 132.

The sensor 124 is installed in the vehicle 104 and includes sensors for acquiring information about the surroundings of the vehicle 104 (e.g., video image capturing device (e.g., digital camera (CCD (Charge-Coupled Device) camera, CMOS (Complementary Metal-Oxide Semiconductor) camera), laser sensor (LiDAR), etc.). Note that the sensor 124 may include sensors (acceleration sensor, load sensor, etc.) for acquiring information about the vehicle itself. The sensor 124 acquires information within a detection range (image capturing range in the case of a camera) and outputs the acquired information as sensor data. The sensor 124 outputs digital image data in the case of being a digital camera. A detection signal (i.e., analog or digital signal) of the sensor 124 is output to the bus 132 as digital data via an I/F unit (not shown), and transmitted to the in-vehicle device 122, the automatic driving ECU 126, and the like.

The automatic driving ECU 126 controls travel of the vehicle 104. For example, the automatic driving ECU 126 acquires sensor data from the sensor 124, analyzes the acquired sensor data to grasp the situation around the vehicle, and transmits information indicating the situation around the vehicle to the drive ECU 130, which is a mechanism relating to automatic driving. The drive ECU 130 controls a drive unit 134 (e.g., mechanism such as engine, motor, transmission, steering and brakes). The automatic driving ECU 126 utilizes the driving assistance information acquired from the in-vehicle device 122 in automatic driving. As will be described later, the authentication ECU 128 executes user authentication in order to permit opening of a door lock of the vehicle 104 or the like.

### Hardware Configuration of Roadside Device

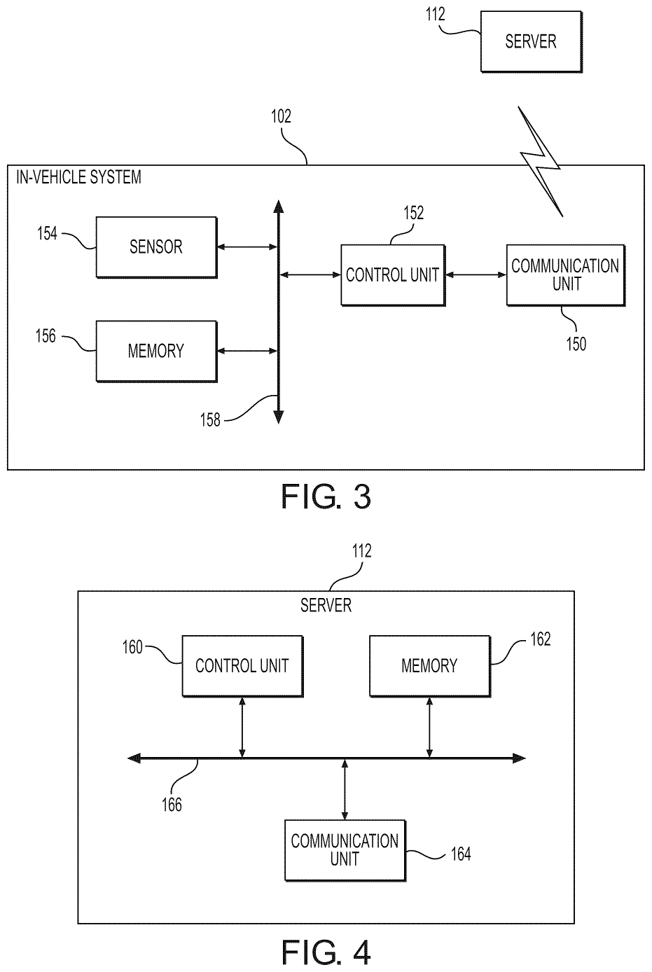

Referring to FIG. 3, an example of the hardware configuration of the roadside device 106 is shown. The roadside device 106 includes a communication unit 150, a control unit 152, a sensor 154, a memory 156 and a bus 158. Data is exchanged between the control unit 152, the sensor 154 and the memory 156 via the bus 158. The communication unit 150 receives data from the server 112 and transmits data to the server 112. The communication unit 150 acquires transmission data from the control unit 152 and outputs reception data to the control unit 152. Data received by the communication unit 150 is stored in the memory 156 as appropriate.

The control unit 152 is constituted to include a CPU, for example. The memory 156 is, for example, a rewritable non-volatile semiconductor memory, and stores programs to be executed by the control unit 152. The memory 156 provides a work area for programs that are executed by the control unit 152. The memory 156 may include a mass storage device such as a hard disk drive. The sensor 154 is a sensor for acquiring information about the surroundings of the roadside device 106, and includes, for example, an image sensor (e.g., digital surveillance camera, etc.), a radar (e.g., millimeter-wave radar, etc.), or a laser sensor (e.g., LiDAR, etc.). The sensor 154 acquires information within a detection range (e.g., image capturing range in the case of a camera) and outputs the acquired information as sensor data. The sensor data is stored in the memory 156.

The control unit 152 reads out sensor data from the memory 156 and outputs the read sensor data to the communication unit 150. The sensor data of the sensor 154 is thereby transmitted from the communication unit 150 to the server 112. Also, the control unit 152 reads out sensor data from the memory 156 and analyzes the read sensor data. As a result of the analysis, dynamic objects and the like is detected. The control unit 152 outputs information about the detected dynamic objects and the like to the communication unit 150. The analysis results of the control unit 152 are thereby transmitted from the communication unit 150 to the server 112, and the server 112 is able to generate information relating to the surroundings of the vehicle 104 (hereinafter, “roadside information”) as described later.

### Hardware Configuration of Server

Referring to FIG. 4, the server 112 includes a control unit 160 that controls the other units, a memory 162 that stores data, a communication unit 164 that performs communication, and a bus 166 for exchanging data between the units. The control unit 160 is constituted to include a CPU, and realizes functions described later by controlling the other units. The memory 162 includes a rewritable non-volatile semiconductor memory and a mass storage device such as a hard disk drive. The communication unit 164 receives data uploaded from the in-vehicle system 102 and the roadside device 106. The data received by the communication unit 164 is transmitted to the memory 162 and stored. The server 112 analyzes the received data to generate roadside information and transmits the generated roadside information to the in-vehicle system 102. In the case of providing a driving assistance service, the server 112 analyzes the received data to generate driving assistance information and transmits the generated driving assistance information to the vehicle (i.e., in-vehicle system).

### Functional Configuration of In-Vehicle System

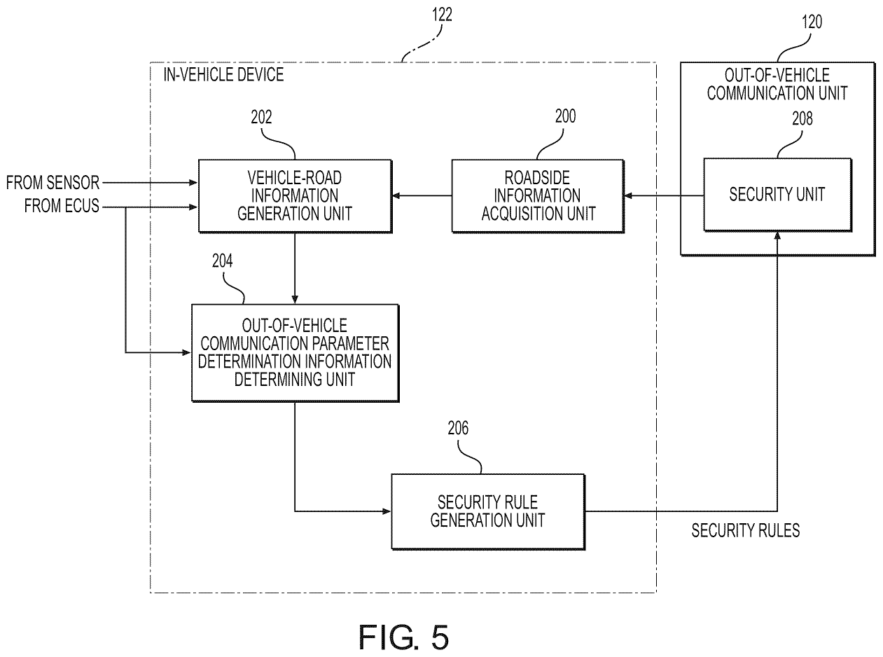

A function of the in-vehicle device 122, that is, the function of controlling security rules, will now be described, with reference to FIG. 5. The in-vehicle device 122 includes a roadside information acquisition unit 200, a vehicle-road information generation unit 202, an out-of-vehicle communication parameter determination information determining unit 204, and a security rule generation unit 206. The functions of the roadside information acquisition unit 200, the vehicle-road information generation unit 202, the out-of-vehicle communication parameter determination information determining unit 204, and the security rule generation unit 206 are realized by the control unit 140 and the memory 142 shown in FIG. 2. The out-of-vehicle communication unit 120 includes a security unit 208 that executes communication security such as packet filtering. As will be described later, the in-vehicle device 122 outputs determined security rules to the security unit 208 and causes the security unit 208 to restrict communication that is executed by the out-of-vehicle communication unit 120 in accordance with the input rules.

The roadside information acquisition unit 200 acquires roadside information transmitted from the server 112 with the out-of-vehicle communication unit 120. The roadside information is information relating to the surroundings of the in-vehicle system 102 and includes map information. The map information includes, for example, a road map of the area around the in-vehicle system 102 and disposition information of out-of-vehicle devices such as servers capable of communicating with the in-vehicle system 102 (hereinafter, “out-of-vehicle device map”). Based on the out-of-vehicle device map, the communication area of each server and the like becomes known, and the communication connection state between the out-of-vehicle device and the vehicle can be derived. The out-of-vehicle device map is utilized when connection information (i.e., information indicating the communication connection state with an external device) described later cannot be directly acquired. The acquired roadside information is stored in the memory 142.

The vehicle-road information generation unit 202 adds the roadside information acquired by the roadside information acquisition unit 200 to the information acquired from the out-of-vehicle communication unit 120, the automatic driving ECU 126, the drive ECU 130, and the like (hereinafter, “vehicle information”) to generate vehicle-road information. The generated vehicle-road information is stored in the memory 142. The vehicle information includes, for example, position information indicating the position of the vehicle 104, application operation information specifying a user-oriented application operating in the vehicle 104, and connection information indicating the communication connection state with an external device. Accordingly, the vehicle-road information includes, for example, position information, map information, application operation information, and connection information. The vehicle-road information generation unit 202 specifies an application operating in the vehicle 104 and is able to generate application operation information by communicating with the other units within the in-vehicle system 102 via the bus 132, for example. As will be described later, the out-of-vehicle communication parameters for generating appropriate security rules can thereby be determined.

The application is, for example, a program that is executed in the in-vehicle system 102 in order to receive a service provided by the server 112. The application need only be a program that can be executed in the vehicle 104, and also includes programs that are executed by an ECU such as the automatic driving ECU 126, the authentication ECU 128, and the drive ECU 130, in addition to programs that are executed by the in-vehicle device 122.

Note that the vehicle-road information may not include connection information, that is, the vehicle-road information generation unit 202 may not be able to acquire connection information. Even in such cases, connection information can be generated from information included in the vehicle-road information, as will be described later. Accordingly, the vehicle-road information need only include at least one of the types of information described above.

The out-of-vehicle communication parameter determination information determining unit 204 determines the out-of-vehicle communication parameter determination information from the vehicle-road information created by the vehicle-road information generation unit 202. The determined out-of-vehicle communication parameter determination information is stored in the memory 142. The out-of-vehicle communication parameter determination information is information for determining security rules relating to wireless communication between the out-of-vehicle communication unit 120 and devices located outside the vehicle 104, that is, information that is utilized in order to determine parameters to be restricted by security rules, among the out-of-vehicle communication parameters relating to out-of-vehicle communication. The out-of-vehicle communication parameter determination information includes, for example, application operation information and connection information. As will be described later, appropriate security rules can thereby be generated. When the vehicle-road information includes any of application operation information and connection information, the out-of-vehicle communication parameter determination information determining unit 204 determines the information included in the vehicle-road information as the out-of-vehicle communication parameter determination information.

As described above, there are also cases where the vehicle-road information does not include connection information. In that case, the out-of-vehicle communication parameter determination information determining unit 204 indirectly determines the connection information that is not included in the vehicle-road information. That is, the out-of-vehicle communication parameter determination information determining unit 204 estimates the connection information that is not included in the vehicle-road information from the information that is included. For example, the out-of-vehicle communication parameter determination information determining unit 204 is able to infer the external device (e.g., IP address and port number) to which the out-of-vehicle communication unit 120 is connected for communication and the communication state (e.g., communication speed) thereof, using the position information and map information (including out-of-vehicle device map) included in the vehicle-road information, and is accordingly able to determine the connection information.

The connection information can thereby be generated from the vehicle-road information, and appropriate security rules can be generated.

The security rule generation unit 206 generates security rules from the out-of-vehicle communication parameter determination information determined by the out-of-vehicle communication parameter determination information 204. The out-of-vehicle communication parameters, which are parameters relating to communication by the out-of-vehicle communication unit 120, include, for example, access frequency from outside, communication amount (i.e., communication speed), number of sessions of communication established, number of SYN packets communicated in order to establish communication, communication destination IP address, and communication destination port number. As will be described later, the safety of communication by the out-of-vehicle communication unit 120 can thereby be improved. The out-of-vehicle communication parameters are not limited thereto. The security rule generation unit 206 specifies the out-of-vehicle communication parameters to be restricted from the out-of-vehicle communication parameter determination information (e.g., application operation information and connection information), determines the restriction contents thereof, and, for example, generates a table (hereinafter, “security rule table”) in which the out-of-vehicle communication parameters and the restriction contents are associated as security rules. The security rule generation unit 206 outputs the determined security rules to the security unit 208 of the out-of-vehicle communication unit 120. Also, the security rule generation unit 206 stores the generated security rules in the memory 142.

Applications are specified by the application operation information, and thus, as long as the specifications of out-of-vehicle communication by the applications are known, the security rule generation unit 206 is able to determine the out-of-vehicle communication parameters, generate a security rule table for each application, and store the generated security rule table in the memory 142. Accordingly, the communication specifications of each application need only be stored in the memory 142 in advance. For example, each application may be analyzed and the communication specifications may be stored in the memory 142. By analyzing applications downloaded and stored in the in-vehicle system 102, the communication conditions of the applications (e.g., communication destination IP address, communication destination port number, communication amount, etc.) can be specified, and security rule tables can be generated. Also, as will be described later, the communication specifications of the applications may be downloaded from a server and stored in the memory 142. Note that, when a plurality of applications are started, out-of-vehicle communication parameters corresponding to each application are obtained, but because the out-of-vehicle communication path to be restricted is one out-of-vehicle communication unit 120, the security rule generation unit 206 integrates the plurality of security rule tables. For example, when each of the plurality of security rule tables includes a communication amount, a security rule including the total value of the communication amounts is generated. When each of the plurality of security rule tables includes a set of a communication destination IP address and a communication destination port number, a security rule including all the sets is generated. Security rules restricting communication of the out-of-vehicle communication unit 120 can thereby be efficiently generated.

The security unit 208 stores the input security rules in an internal memory, and restricts communication that is executed by the out-of-vehicle communication unit 120, in accordance with the security rules. Accordingly, the safety of communication by the out-of-vehicle communication unit 120 can be improved. The above processing by the roadside information acquisition unit 200, the vehicle-road information generation unit 202, the out-of-vehicle communication parameter determination information determining unit 204, and the security rule generation unit 206 is repeatedly executed, and security rules are repeatedly generated. The vehicle-road information changes according to changes in the operation status of applications in the vehicle 104 and the connection state with external devices, and the out-of-vehicle communication parameter determination information changes according to changes in the vehicle-road information. Accordingly, the security rules change, according to changes in the operation status of applications in the vehicle 104 and the connection state with external devices. When security rules are newly input from the security rule generation unit 206, the security unit 208 rewrites and updates the security rules stored in the internal memory with the new security rules.

The in-vehicle system 102 (specifically, in-vehicle device 122) is thereby able to determine appropriate security rules according to the operation status of applications in the vehicle 104 in which the in-vehicle system 102 is installed and the connection state with external devices. Also, the in-vehicle system 102 is able to dynamically control the security rules according to changes in the operation status of applications in the vehicle 104 and the connection state with external devices. Accordingly, cybersecurity attacks can be countered and the security of communication with the outside can be improved. Determination of security rules is possible by processing information that can be acquired inside the vehicle 104 and information that can be acquired from a server, and can thus be realized with a low computational cost, without executing processing that requires many resources such as machine learning.

Note that the case where the security rule generation unit 206 stores a security rule table for each application is described above, but the present disclosure is not limited thereto. The security rule generation unit 206 need only store out-of-vehicle communication parameters that are used in order to generate security rules for each application. The storage format may be a format other than a table.

### Operation of In-Vehicle Device

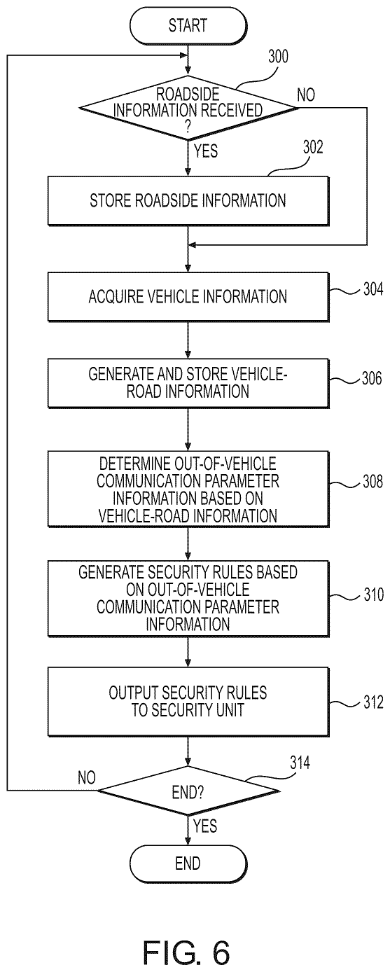

The functions shown in FIG. 5 will be referred to in describing an operation for controlling security rules by the in-vehicle device 122, with reference to FIG. 6. The processing shown in FIG. 6 is realized as a result of power being supplied to the in-vehicle system 102 from an in-vehicle battery or the like, and the control unit 140 (see FIG. 2) of the in-vehicle device 122 reading out and executing a predetermined program from the memory 142. Note that the results obtained by executing the processing shown below are stored in the memory 142 as appropriate.

In step 300, the control unit 140 determines whether roadside information has been received via the out-of-vehicle communication unit 120. If it is determined that roadside information has been received, control moves to step 302. If this is not the case, control moves to step 304. Roadside information is transmitted from the server 112, for example.

In step 302, the control unit 140 stores the roadside information received in step 300 in the memory 142. Thereafter, control moves to step 304. The processing of steps 300 and 302 corresponds to the function of the roadside information acquisition unit 200 in FIG. 5.

In step 304, the control unit 140 acquires vehicle information of the vehicle 104 in which the in-vehicle system 102 is installed. The control unit 140 stores the acquired vehicle information in the memory 142. Thereafter, control moves to step 306. The vehicle information includes, for example, position information of the vehicle 104, application operation information, and connection information. The vehicle 104 acquires the vehicle information from the out-of-vehicle communication unit 120, the automatic driving ECU 126, the drive ECU 130, and the like.

In step 306, the control unit 140 reads out the vehicle information acquired in step 304 and the roadside information received in step 300 from the memory 142, combines the vehicle information and the roadside information to generate vehicle-road information, and stores the generated vehicle-road information in the memory 142. If duplicate information is included in the vehicle information and the roadside information, the control unit 140 includes one thereof in the vehicle-road information. Thereafter, control moves to step 308. The processing of steps 304 and 306 corresponds to the function of the vehicle-road information generation unit 202 in FIG. 5.

In step 308, the control unit 140 determines the out-of-vehicle communication parameter determination information, based on the vehicle-road information generated in step 306 and stores the determined out-of-vehicle communication parameter determination information in the memory 142. Thereafter, control moves to step 310. The processing of step 308 corresponds to the function of the out-of-vehicle communication parameter determination information determining unit 204 shown in FIG. 5.

In step 310, the control unit 140 generates security rules based on the out-of-vehicle communication parameter determination information determined in step 308. Thereafter, control moves to step 312.

In step 312, the control unit 140 outputs the security rules to the security unit 208. Thereafter, control moves to step 314. The processing of steps 310 and 312 corresponds to the function of the security rule generation unit 206 shown in FIG. 5.

In step 314, the control unit 140 determines whether to end the processing. If it is determined to end the processing, the program is ended. If this is not the case, control returns to step 300 and the processing described above is repeated.

The end instruction is given, for example, by power supply to the in-vehicle device 122 being stopped.

### Operation of Security Unit

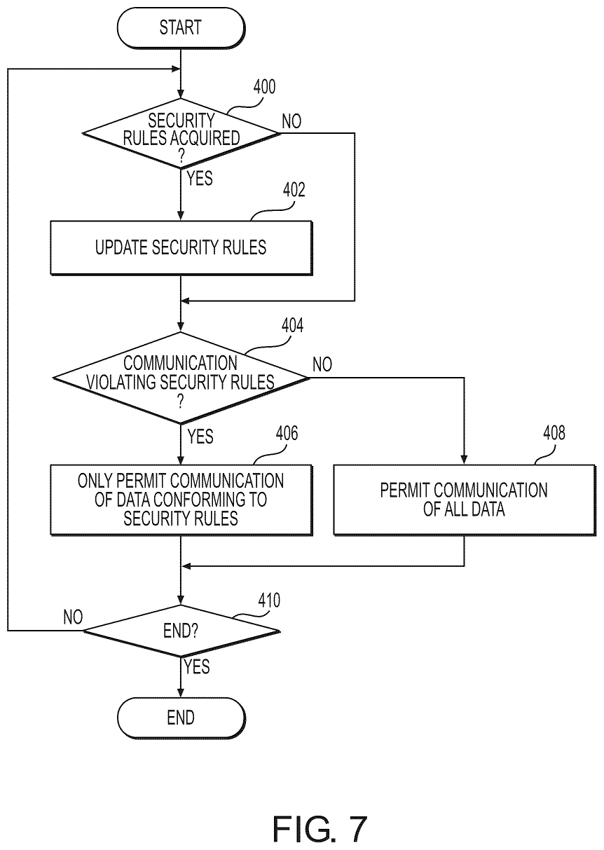

An operation for restricting communication by the security unit 208 (see FIG. 5) of the out-of-vehicle communication unit 120 will be described, with reference to FIG. 7. The processing shown in FIG. 7 is realized, for example, by a control unit (e.g., CPU) inside the security unit 208 reading out a predetermined program from the internal memory of the security unit 208 and executing the program.

In step 400, the security unit 208 determines whether security rules have been acquired from the in-vehicle device 122. If it is determined that security rules have been acquired, control moves to step 402. If this is not the case, control moves to step 404. The security rules are output from the in-vehicle device 122 to the security unit 208 in step 312 shown in FIG. 6.

In step 402, the security unit 208 updates the security rules currently in use. Specifically, the security unit 208 replaces the security rules currently in use with the security rules acquired in step 400 (e.g., overwrites the security rules in the internal memory of security unit 208). Thereafter, control moves to step 404.

In step 404, the security unit 208 determines whether there is communication that violates the security rules. If it is determined that there is such communication, control moves to step 406. If this is not the case, control moves to step 408. Communication that violates the security rules means communication that deviates from the range of out-of-vehicle communication parameters stipulated as security rules. For example, if the security rules include a communication amount as an out-of-vehicle communication parameter and the threshold value (i.e., upper limit value) thereof is set to “a” (bps), the security unit 208 determines that there is communication that violates the security rules, when data exceeding “a” (bps) is received from outside the vehicle 104. For example, in the case where the security rules include the communication destination IP address as an out-of-vehicle communication parameter, the security unit 208 determines that there is communication that violates the security rules, when packet data including an IP address different from the communication destination IP address is received as the transmission source address.

Note that the period for executing the processing in step 404 can vary depending on the out-of-vehicle communication parameters included in the security rules. For example, if the security rules include the communication destination IP address as an out-of-vehicle communication parameter, the security unit 208 need only determine, for each received packet, whether the transmission source address included in the packet is the communication destination IP address. On the other hand, when the security rules include a communication amount (threshold value is “a” (bps)) as an out-of-vehicle communication parameter, packets received over a predetermined period are buffered, and it is determined whether the total value is not greater than “a” (bps).

In step 406, the security unit 208 only enables communication of data that conforms to the security rules. That is, the security unit 208 discards received packets determined to violate the security rules in step 404 and does not pass those packets to the application. The security unit 208 passes received packets determined not to violate the security rules in step 404 to the applications corresponding to the respective port numbers included in those packets. Thereafter, control moves to step 410.

In step 408, the security unit 208 enables communication of all received data and passes the packets to the applications corresponding to the respective port numbers included in the packets. Thereafter, control moves to step 410.

In step 410, the security unit 208 determines whether to end the processing. If it is determined to end the processing, the program is ended. If this is not the case, control returns to step 400 and the processing described above is repeated. The end instruction is given, for example, by power supply to the out-of-vehicle communication unit 120 being stopped.

In the manner described above, the in-vehicle system 102 (specifically, in-vehicle device 122) is able to determine appropriate security rules that depend on the operation status of applications in the vehicle 104 in which the in-vehicle system 102 is installed and the connection state with external devices. Also, the in-vehicle system 102 is able to dynamically control the security rules, according to changes in the operation status of applications in the vehicle 104 and the connection state with external devices. Accordingly, the in-vehicle system 102 is able to counter cybersecurity attacks and improve the safety of communication with the outside. Determination of security rules is possible by processing information that can be acquired inside the vehicle 104 and information that can be acquired from a server, and can thus be realized with a low computational cost, without executing processing that requires many resources such as machine learning.

The case where the in-vehicle device 122 acting as a gateway has a function of controlling security rules is described above, but the present disclosure is not limited thereto. Elements other than the in-vehicle device 122 constituting the in-vehicle system 102 (e.g., out-of-vehicle communication unit 120) may have a function of controlling the security rules. Also, the in-vehicle system 102 may have a dedicated ECU for controlling security rules. The out-of-vehicle communication unit 120, the dedicated ECU, and the like are also installed in the vehicle 104 and are included as in-vehicle devices.

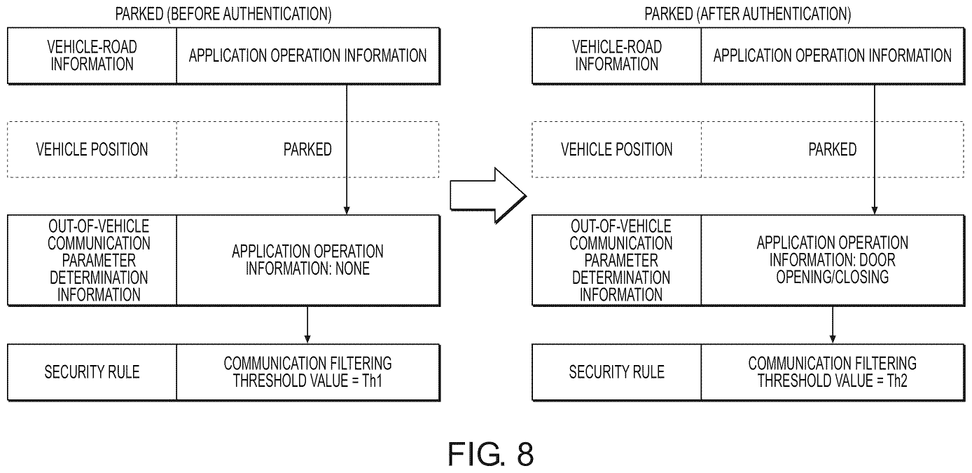

Specific examples will now be illustrated with reference to FIGS. 8 to 12.

### First Example

An example in which application operation information that is included in the out-of-vehicle communication parameter determination information utilized in generating security rules is directly determined will be described, with reference to FIG. 8. Here, it is assumed that the doors of the vehicle 104 are locked when the vehicle 104 is parked, and an application that opens and closes (i.e., unlocks and locks) the doors of the vehicle 104 is started after authentication is performed. The left side of FIG. 8 shows information when the vehicle 104 is parked and before authentication is performed. The right side of FIG. 8 shows information when the vehicle 104 is parked and after authentication is performed. Authentication is performed utilizing the user's smartphone, for example, and the authentication ECU 128 of the in-vehicle system 102 (see FIG. 2) communicates with the user's smartphone via the out-of-vehicle communication unit 120. For example, the authentication ECU 128 of the in-vehicle system 102 receives an authentication trigger signal transmitted from the user's smartphone.

The vehicle-road information includes application operation information. As described above, the in-vehicle device 122 communicates with the other units of the in-vehicle system 102 and is able to acquire the application operation information included in the vehicle-road information. The vehicle 104 is stationary, the doors are locked, there are no applications operating, and the application operation information included in the vehicle-road information is set to information indicating that there are no applications operating (e.g., “none”). The in-vehicle device 122 is able to specify that authentication has not been performed by the fact that the authentication ECU 128 has not received the authentication trigger signal. The in-vehicle device 122 determines the application operation information of the out-of-vehicle communication parameter determination information to be “none” directly from the application operation information included in the vehicle-road information. The in-vehicle device 122 thereby sets the communication filtering threshold value (i.e., upper limit value) corresponding to the restriction on the communication amount to Th1 as a security rule. Th1 is a value small enough to enable the in-vehicle device 122 to receive an authentication trigger signal from the outside (i.e., user's smartphone) via the out-of-vehicle communication unit 120. Th1 need only be set in advance to an appropriate value.

Authentication is performed upon the authentication ECU 128 receiving the authentication trigger signal, and the in-vehicle device 122 acquires information indicating that authentication has been performed from the authentication ECU 128. The in-vehicle device 122 is able to specify that the vehicle 104 is parked and that authentication has been performed. Also, the in-vehicle device 122 communicates with the other units of the in-vehicle system 102, specifies that the door opening/closing application is operating, and sets information (i.e., “door opening/closing”) specifying the door opening/closing application in the application operation information included in the vehicle-road information. The in-vehicle device 122 determines the application operation information of the out-of-vehicle communication parameter determination information to be “door opening/closing” directly from the application operation information included in the vehicle-road information. FIG. 8 shows the case where the name of the application is used as information specifying the application, but a number, symbol, or combination thereof that uniquely corresponds to each application may be used. From the out-of-vehicle communication parameter determination information, the in-vehicle device 122 sets the communication filtering threshold value relating to the restriction on the communication amount to Th2 as a security rule. Th2 is a value greater than Th1. For example, Th2 need only be set to a value at which data transmitted from a smartphone (e.g., including code for specifying locking or unlocking) as a result of the user performing a screen operation on the smartphone (e.g., touch operation on a lock button or an unlock button displayed on the touch panel) can be received. Also, assuming that applications other than the door opening/closing application are operated, Th2 may be determined with consideration for the communication data amount thereof. Note that as long as applications that can be started in the in-vehicle system 102 and the out-of-vehicle communication parameters (e.g., communication amount, communication destination IP address, communication destination port number, etc.) thereof are stored in the memory 142 in association with each other, security rules can be generated based on the application operation information.

If data exceeding the expected communication amount (i.e., Th1) is transmitted to the in-vehicle system 102 when the vehicle 104 is parked and before authentication is performed, it thereby becomes possible to filter the transmission data. Accordingly, it becomes possible to counter DOS attacks, for example.

### Second Example

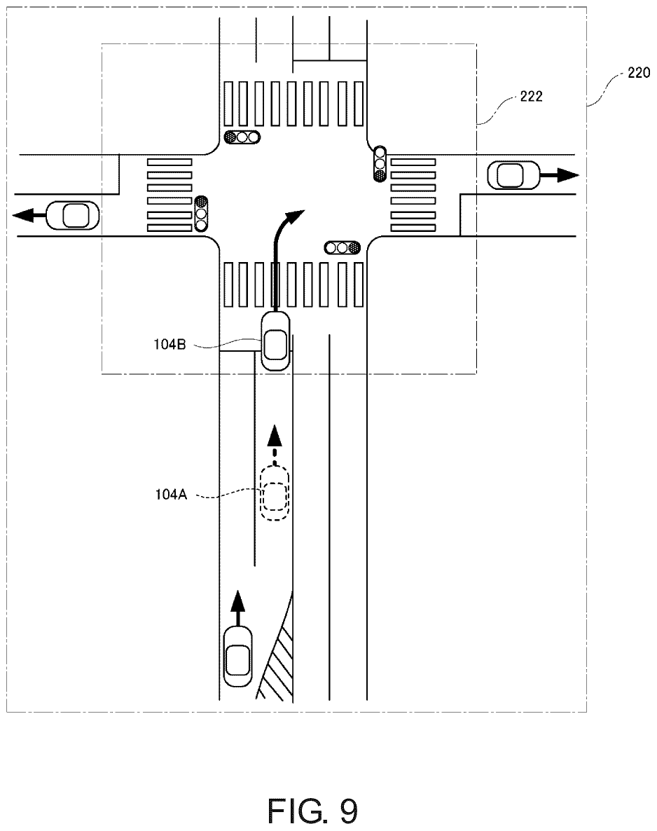

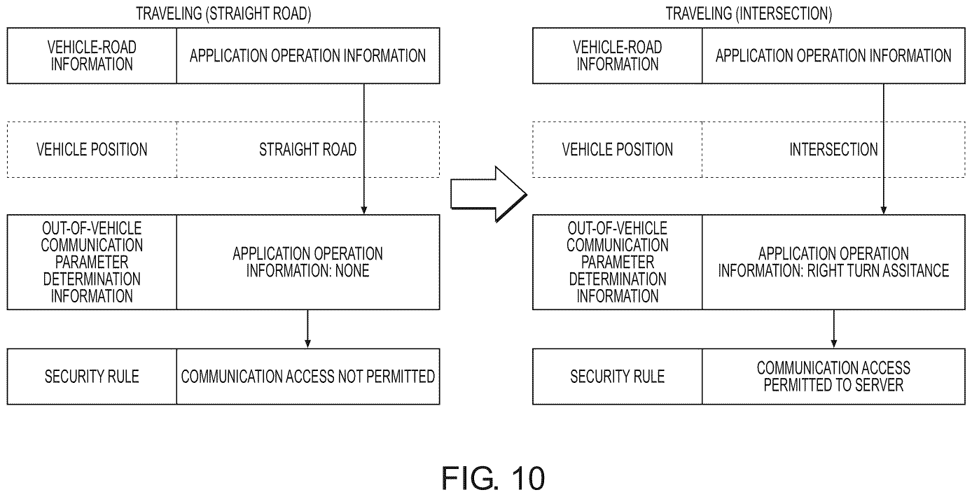

FIGS. 9 and 10 show a different example from FIG. 8 in which the application operation information that is included the out-of-vehicle communication parameter determination information utilized in generation of security rules is directly determined. Here, with reference to FIG. 9, it is assumed that a driving assistance service of an edge server (not shown) is provided in an edge service area 222 that includes an intersection, and that the service is not provided in a larger cloud service area 220 that includes the edge service area 222. In FIG. 9, the current positions of vehicles are shown by solid lines, and past positions are indicated by dashed lines. Vehicles 104B and 104A indicate current and past vehicle positions of the same vehicle 104. The driving direction of each vehicle is indicated by an arrow.

Referring to FIG. 10, the left side shows information when the vehicle 104A is located on a straight road outside the edge service area 222. The right side of FIG. 10 shows information when the vehicle 104B is located within the edge service area 222. The vehicle-road information includes application operation information. The in-vehicle device 122 of the vehicle 104A located on a straight road outside the edge service area 222 communicates with the other units of the in-vehicle system 102, specifies that there are no applications operating, and sets “none” in the application operation information included in the vehicle-road information. The in-vehicle device 122 thereby determines the application operation information of the out-of-vehicle communication parameter determination information to be “none” directly from the application operation information included in the vehicle-road information. As a result, the in-vehicle device 122 sets, as a security rule, that communication access permission is not given, that is, that out-of-vehicle communication is not permitted.

The in-vehicle device 122 of the vehicle 104B located in the right turn lane of the intersection within the edge service area 222 communicates with the other units of the in-vehicle system 102, specifies that the right turn assistance application is operating, and sets information (i.e., “right turn assistance”) specifying the right turn assistance application. The in-vehicle device 122 thereby determines the application operation information of the out-of-vehicle communication parameter determination information to be “right turn assistance” directly from the application operation information included in the vehicle-road information. From this out-of-vehicle communication parameter determination information, the in-vehicle device 122 permits communication access with the edge server providing the right turn assistance information service. That is, the in-vehicle device 122 generates a security rule in which the communication destination IP address and the communication destination port number are set to the IP address and port number of the edge server.

If there is access from an unexpected communication destination to the in-vehicle system 102 when the vehicle 104 is located in an area not covered by the service, access therefrom can thereby be restricted. For example, it becomes possible to counter access that falsifies the communication destination (i.e., spoofing).

### Third Example

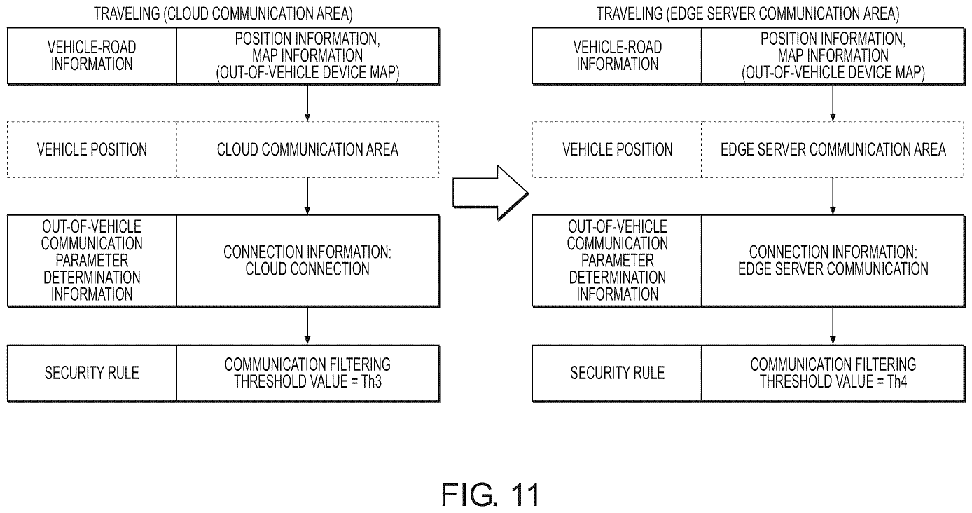

An example in which connection information (i.e., information indicating the communication connection state with an external device) that is included in the out-of-vehicle communication parameter determination information utilized in generating security rules is indirectly determined will be described, with reference to FIG. 11. Here, it is assumed that the position of the vehicle 104 changes similarly to the second example (see FIG. 9). In the third example, unlike the second example, it is assumed, however, that the in-vehicle system 102 communicates with a cloud server (not shown) in the cloud service area 220 outside the edge service area 222. Note that, here, connection information will be described and description of application operation information will be omitted.

Referring to FIG. 11, the left side shows information when the vehicle 104A is within the cloud service area 220 but is located on a road outside the edge service area 222, and the right side shows information when the vehicle 104B is located on a road within the edge service area 222. The vehicle-road information includes position information and map information, and does not include connection information, for example. The in-vehicle device 122 of the vehicle 104A is able to specify the vehicle position as the cloud service area 220 (i.e., cloud communication area) outside the edge service area 222 from the vehicle-road information (e.g., position information and map information). The in-vehicle device 122 determines the connection information of the out-of-vehicle communication parameter determination information to be a cloud connection.

As a result, the in-vehicle device 122 sets the communication filtering threshold value (i.e., upper limit value) corresponding to the restriction on the communication amount to Th3 as a security rule. Th3 may be set in advance based on the service provided by the cloud server.

The in-vehicle device 122 of the vehicle 104B is able to specify the vehicle position within the edge service area 222 (i.e., edge server communication area) from the vehicle-road information. The in-vehicle device 122 determines the connection information of the out-of-vehicle communication parameter determination information to be an edge server connection. As a result, the in-vehicle device 122 sets the communication filtering threshold value corresponding to the restriction on the communication amount to Th4 as a security rule. Th4 need only be set in advance based on the service (e.g., right turn assistance service) provided by the edge server. In general, communication between an in-vehicle system and an edge server that provides a service in a small area such as an intersection is considered to be more real-time than communication with a cloud server that provides a service in a large area, given that there are many dynamic objects such as people in the vicinity of the vehicle. Accordingly, Th4>Th3 is set, for example.

If data exceeding the communication amount expected from the connection state is transmitted to the in-vehicle system 102 when the vehicle 104 is located within the cloud communication area, it thereby becomes possible to filter the transmission data. Accordingly, it becomes possible to counter DOS attacks, for example.

### Fourth Example

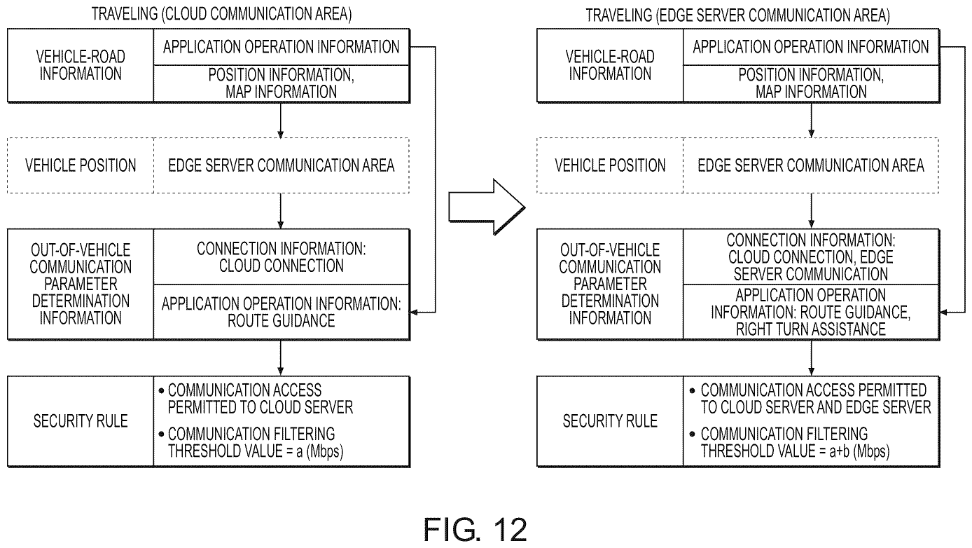

An example in which security rules are generated when a plurality of applications are operating will be described, with reference to FIG. 12. Here, it is assumed that the position of the vehicle 104 changes similarly to the second example (see FIG. 9). In the fourth example, unlike the second example, it is assumed, however, that the in-vehicle system 102 operates a route guidance application and communicates with a cloud server in the cloud service area 220 that includes the edge service area 222.

Referring to FIG. 12, the left side shows information when the vehicle 104A is within the cloud service area 220 but is located on a road outside the edge service area 222, and the right side shows information when the vehicle 104B is located on a road within the edge service area 222. The vehicle-road information includes position information, map information, and application operation information, for example. The in-vehicle device 122 of the vehicle 104A is able to specify the vehicle position as the cloud service area 220 (i.e., cloud communication area) from the position information and map information included in the vehicle-road information. The in-vehicle device 122 thereby sets “cloud connection” in the connection information of the out-of-vehicle communication parameter determination information. Also, the in-vehicle device 122 communicates with the other units of the in-vehicle system 102, specifies that the route guidance application is operating, and sets information (i.e., “route guidance”) specifying the route guidance application in the application operation information included in the vehicle-road information. The in-vehicle device 122 thereby sets “route guidance” in the application operation information of the out-of-vehicle communication parameter determination information directly from the application operation information included in the vehicle-road information.

From the out-of-vehicle communication parameter determination information (i.e., connection information is “cloud connection”, application operation information is “route guidance”), the in-vehicle device 122 permits communication access with the cloud server providing the route guidance service. That is, the in-vehicle device 122 generates a security rule in which the communication destination IP address and the communication destination port number are set to the IP address and port number of the cloud server, and the communication filtering threshold value (i.e., upper limit value) corresponding to the restriction on the communication amount is “a” (Mbps). “a” (Mbps) need only be set in advance based on the route guidance service.

The in-vehicle device 122 of the vehicle 104B is able to specify the vehicle position as the right turn lane of the intersection within the edge service area 222 included in the cloud service area 220 from the position information and map information included in the vehicle-road information. The in-vehicle device 122 thereby sets “cloud connection” and “edge server connection” in the connection information of the out-of-vehicle communication parameter determination information. Also, the in-vehicle device 122 communicates with the other units of the in-vehicle system 102, specifies that the right turn assistance application is operating in addition to the route guidance application that is already operating, and sets “route guidance” and information specifying the right turn assistance application (i.e., “right turn assistance”) in the application operation information included in the vehicle-road information. The in-vehicle device 122 thereby sets “route guidance” and “right turn assistance” in the application operation information of the out-of-vehicle communication parameter determination information directly from the application operation information included in the vehicle-road information. From this out-of-vehicle communication parameter determination information (i.e., connection information is “cloud connection” and “edge server connection”, application operation information is “route guidance” and “right turn assistance”), the in-vehicle device 122 permits communication access with the cloud server providing the route guidance service and the edge server providing the right turn assistance service. That is, the in-vehicle device 122 generates a security rule in which the communication destination IP address and the communication destination port number are set to the IP addresses and port numbers of the cloud server and the edge server, and the communication filtering threshold value (i.e., upper limit value) corresponding to the restriction on the communication amount is “a+b” (Mbps). “b” (Mbps) is a value set in advance based on the right turn assistance service.

If data exceeding the communication amount expected from the connection state is transmitted to the in-vehicle system 102 when the vehicle 104 is located in the cloud communication area, it thereby becomes possible to filter the transmission data. Accordingly, it becomes possible to counter DOS attacks, for example. Also, if there is access from an unexpected communication destination to the in-vehicle system 102 when the vehicle 104 is located in an area in which a server provides the service, access therefrom can be restricted. For example, it becomes possible to counter access that falsifies the communication destination (i.e., spoofing).

### Variation

The application that operates in the vehicle 104 may be an application that the in-vehicle system 102 has newly downloaded from a server. Also, an application already stored in the in-vehicle system 102 may be updated, that is, the in-vehicle system 102 may download a new version of the application (hereinafter, “updated application”) from the server. In both cases, generation of security rules in the in-vehicle system 102 is affected. The communication system according to the variation is able to address this and efficiently generate security rules.

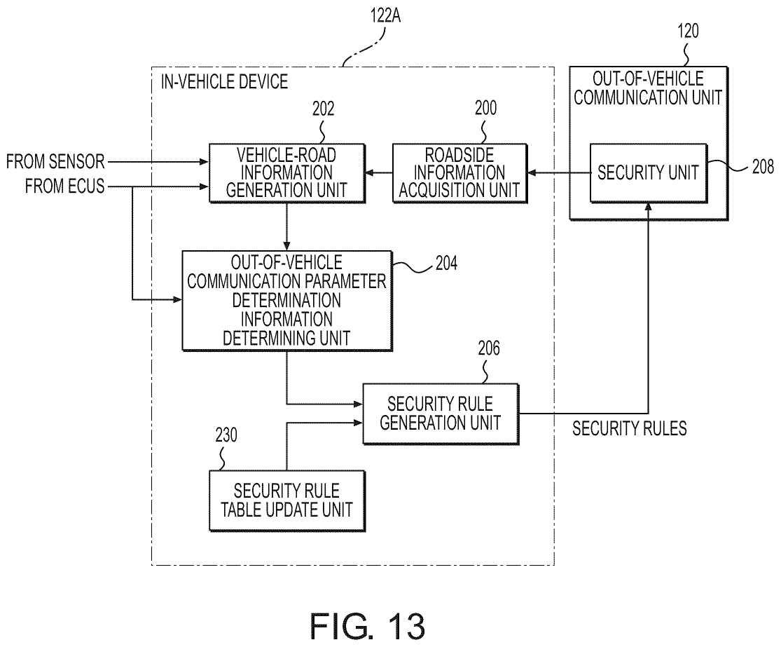

The communication system according to the variation is configured similarly to the communication system 100 shown in FIG. 1, and the hardware configuration of the in-vehicle system, the roadside device, and the server are similar to FIGS. 2, 3 and 4. In the communication system according to the variation, unlike the communication system 100, applications (including updated applications) are, however, transmitted from the server 112, with FIG. 5 which shows the functional configuration of the in-vehicle device of the in-vehicle system being replaced by FIG. 13. Hereinafter, the reference numerals shown in FIGS. 1 to 4 will be referred to as appropriate.

### Functional Configuration of In-Vehicle System According to Variation

A function of the in-vehicle device 122A according to the variation, that is, the function relating to control of security rules, will be described, with reference to FIG. 13. The in-vehicle device 122A includes a roadside information acquisition unit 200, a vehicle road information generation unit 202, an out-of-vehicle communication parameter determination information determining unit 204, a security rule generation unit 206, and a security rule table update unit 230. The out-of-vehicle communication unit 120 includes a security unit 208 that executes communication security such as packet filtering. FIG. 13 is a diagram in which the security rule table update unit 230 is added to FIG. 5. In FIG. 13, the functions of elements having reference numerals that are the same as reference numerals shown in FIG. 5 are the same as FIG. 5. Accordingly, hereinafter, description will focus on the differences and redundant description will not be repeated.

The function of the security rule table update unit 230 is realized by the control unit 140 and the memory 142 shown in FIG. 2, similarly to the roadside information acquisition unit 200, the vehicle-road information generation unit 202, the out-of-vehicle communication parameter determination information determining unit 204, and the security rule generation unit 206. The roadside information acquisition unit 200 acquires roadside information transmitted from the server 112 with the out-of-vehicle communication unit 120. The vehicle-road information generation unit 202 generates vehicle-road information by adding the roadside information acquired by the roadside information acquisition unit 200 to the vehicle information acquired from the out-of-vehicle communication unit 120, the automatic driving ECU 126, the drive ECU 130, and the like. The out-of-vehicle communication parameter determination information determining unit 204 determines the out-of-vehicle communication parameter determination information from the vehicle-road information created by the vehicle-road information generation unit 202. The security rule generation unit 206 generates security rules from the out-of-vehicle communication parameter determination information determined by the out-of-vehicle communication parameter determination unit 204, and outputs the generated security rules to the security unit 208 of the out-of-vehicle communication unit 120. The security rule generation unit 206 generates a security rule table for each application and stores the generated security rule tables in the memory 142. The security unit 208 restricts communication that is executed by the out-of-vehicle communication unit 120, in accordance with the input security rules.

The security rule table update unit 230 determines whether a new application or updated application has been downloaded from the server 112, and updates the security rule table if it is determined that such an application has been downloaded. Specifically, when a new application is downloaded, the security rule table update unit 230 determines the out-of-vehicle communication parameters of the downloaded application from the communication specifications of that application, generates a security rule table, and stores the generated security rule table in the memory 142. When an updated application is downloaded, the security rule table update unit 230 determines the out-of-vehicle communication parameters of the downloaded application from the communication specifications of that application, generates a security rule table, and overwrites the old version of the security rule table already stored in the memory 142.

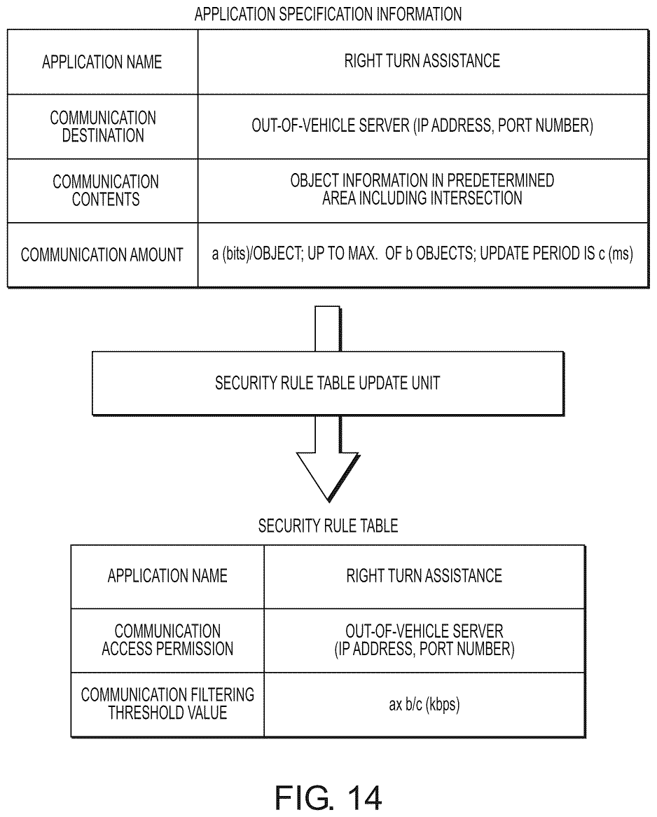

Referring to FIG. 14, an example of application specification information indicating application specifications and a security rule table is shown. Application specification information for receiving right turn assistance is shown in table format in the upper part of FIG. 14. The application specification information can be generated as a result of the application downloaded from the server 112 by the in-vehicle device 122 being analyzed. The communication destination field indicates who the entity (i.e., in-vehicle system 102) that executes the application communicates with, and includes an IP address of an out-of-vehicle server (i.e., server 112) and a port number for specifying the service. The communication content field indicates information that is transmitted from the server 112 as a service, and is information relating to entities (primarily, dynamic objects) within a predetermined area including an intersection that is covered by the service of the server 112. The communication amount field includes information for calculating the communication amount of transmission from the server 112 to the in-vehicle system. That is, a maximum of “a” (bits) is allocated for one object in a predetermined area, the upper limit of the number of objects to which data is allocated is “b”, and an update period of information that is transmitted from the server 112 is “c” (ms) are included.

The security rule table update unit 230 generates a security rule table such as shown in table format in the lower part of FIG. 14 from the application specification information. Communication access permission is set to the IP address and port number of an out-of-vehicle server (i.e., server 112) serving as the communication destination. The communication filtering threshold value (i.e., upper limit value) is a value calculated from the information included in the communication amount field of the application specification information.

When the downloaded application is operated, the out-of-vehicle communication parameter determination information determining unit 204 determines the out-of-vehicle communication parameter specific information, using the out-of-vehicle communication parameters newly stored in the memory 142. Based the determined out-of-vehicle communication parameter specific information, the security rule generation unit 206 generates new security rules, using the new security rule table stored in the memory 142.

Note that an updated application may be an important application, and it may be necessary to promptly operate the updated application instead of the application that is currently operating. In such a case, the application that is operating is promptly stopped and the updated application is operated, and the out-of-vehicle communication parameter determination information determining unit 204 is caused to determine the out-of-vehicle communication parameter specific information, using the out-of-vehicle communication parameters newly stored in the memory 142. The security rule generation unit 206 thereby generates new security rules.

In this way, the security rules can be maintained in an appropriate state, by updating the security rules (specifically, security rule table) through downloading of applications (including new applications and updated applications).

The case where application specification information is generated by the in-vehicle device 122 analyzing applications downloaded from the server 112 is described above, but the present disclosure is not limited thereto. Application specification information may be transmitted from the server 112 to the in-vehicle device 122. The server 112 that transmits applications stores the specifications of the applications, and is thus able to generate application specification information and transmitted the generated application specification information to the in-vehicle device 122. The load due to computational processing for determining the security rules in the in-vehicle device 122 can thereby be reduced.

For example, the server 112 transmits the specification information of applications when transmitting new applications and updated applications to the in-vehicle system 102. The in-vehicle device 122 no longer needs to analyze the applications that operate, in order to generate security rules, as a result of receiving the specification information of applications that are executed in the in-vehicle system 102 from a device external to the in-vehicle system 102. Accordingly, the in-vehicle device 122 is able to further reduce the load due to computational processing for determining the security rules according to the operation status of applications.

The case where the in-vehicle system 102 (specifically, in-vehicle device 122) generates security rules and restricts out-of-vehicle communication in accordance therewith is described above, but the present disclosure is not limited thereto. An external device (e.g., server 112 or roadside device 106) outside the vehicle 104 may generate security rules for the in-vehicle system 102 and transmit the generated security rules to the in-vehicle system 102, and the in-vehicle system 102 may restrict out-of-vehicle communication, in accordance with the received security rules. For example, the server 112 can include a generation unit that generates security rules for restricting out-of-vehicle communication of the vehicle 104 by the in-vehicle system 102, based on information relating to the surroundings of the vehicle 104 and vehicle-road information including vehicle information of the vehicle 104, and a communication unit that transmits the security rules to the in-vehicle system 102. The in-vehicle system 102 is thereby able to dynamically control out-of-vehicle communication, in accordance with the security rules received from the server 112.

Also, the communication unit 164 of the server 112 is able to receive vehicle information of the vehicle 104 from the in-vehicle system 102. The server 112 can further include a vehicle-road information generation unit that generates vehicle-road information by adding the vehicle information received by the communication unit 164 to the roadside information which is information external to the vehicle 104, and a determination unit that determines the out-of-vehicle communication parameter determination information based on the vehicle-road information, and the generation unit is able to generate security rules, based on the out-of-vehicle communication parameter determination information. The load due to computational processing for determining security rules in the in-vehicle system 102 can thereby be reduced.

Note that the various processing (various functions) of the embodiment described above may be realized by circuitry including one or more processors. In addition to the one or more processors, the circuitry may be constituted by one or more memories, an integrated circuit in which any of various analog circuits and various digital circuits are combined, and the like. The one or more memories store programs (instructions) for causing the one or more processors to execute the various processing described above. The one or more processors may execute the various processing described above in accordance with programs read out from the one or more memories, or may execute the various processing in accordance with a logic circuit designed in advance to execute the various processing. The processors may be various types of processors compatible with computer control, such as a CPU, a GPU (Graphics Processing Unit), a DSP (Digital Signal Processor), a FPGA (Field Programmable Gate Array), and an ASIC (Application Specific Integrated Circuit).

Also, a recording medium having a program that causes a computer to execute the processing of the in-vehicle system 102 (specifically, processing executed by the in-vehicle device 122 (e.g., processing shown in FIG. 6)) recorded thereon can be provided. The recording medium is, for example, an optical disc (DVD (Digital Versatile Disc)) or a removable semiconductor memory (USB (Universal Serial Bus) memory, etc.). While computer programs can be transmitted over a communication line, the recording medium referred to here is a non-transitory recording medium. By causing a program stored in the recording medium to be loaded into a computer installed in the vehicle, it is possible for the computer to transmit data that can be effectively utilized by the service provided by an external device such as a roadside device, with consideration for delay time and communication bandwidth, when the in-vehicle system uploads data to the external device, as described above.

### Supplementary Note

That is to say, a computer-readable non-transitory recording medium stores a computer program that causes a computer installed in a vehicle to realize a security function of causing a communication unit that communicates with an external device located outside the vehicle to restrict communication with the external device, in accordance with a security rule generated based on vehicle-road information including vehicle information of the vehicle and roadside information which is information relating to surroundings of the vehicle, the vehicle information including at least one of application operation information specifying an application operating in the vehicle and connection information indicating a communication connection state with the external device.

While the present disclosure has been described above by describing an embodiment, the above-described embodiment is exemplary, and the present disclosure is not restricted to only the above-described embodiment. The scope of the present disclosure is indicated by the individual claims provided in the patent claims, with reference to the detailed description of the disclosure, and embraces all changes that come within the meaning and range of equivalency of the wording contained therein.

1. An in-vehicle device configured to be installed in a vehicle, the in-vehicle device comprising:
a processor that is configured to cause communication unit that communicates with an external device located outside the vehicle to restrict communication with the external device, in accordance with a security rule generated based on vehicle-road information that includes vehicle information of the vehicle and roadside information which is information relating to surroundings of the vehicle,
wherein the vehicle information includes at least one of application operation information that specifies an application operating in the vehicle and connection information that indicates a communication connection state with the external device.

2. The in-vehicle device according to claim 1, wherein the security rule is received from the external device.

3. The in-vehicle device according to claim 1, wherein the processor is configured to:
acquire the roadside information from the external device;
generate the vehicle-road information by adding the vehicle information to the roadside information;
determine out-of-vehicle communication parameter determination information, based on the vehicle-road information; and
generate the security rule, based on the out-of-vehicle communication parameter determination information.

4. The in-vehicle device according to claim 3, wherein the vehicle-road information includes at least one of position information and map information, in addition to the at least one of the application operation information and the connection information.

5. The in-vehicle device according to claim 3, wherein the out-of-vehicle communication parameter determination information includes at least one of the application operation information and the connection information.

6. The in-vehicle device according to claim 5, wherein:
the out-of-vehicle communication parameter determination information includes at least the application operation information, and
the processor is configured to:
generate, when the application operation information specifies that there is no application operating, the security rule to include a first communication filtering threshold value, and
generate, when the application operation information specifies an application that controls door opening and closing of the vehicle, the security rule to include a second communication filtering threshold value greater than the first communication filtering threshold value.

7. The in-vehicle device according to claim 5, wherein:
the out-of-vehicle communication parameter determination information includes at least the application operation information, and
the processor is configured to:
generate, when the application operation information specifies that there is no application operating, the security rule to not include access permission, and
generate, when the application operation information specifies that a driving assistance application is operating, the security rule to include access permission to an external device that provides a service to the driving assistance application.

8. The in-vehicle device according to claim 5, wherein:
the out-of-vehicle communication parameter determination information includes at least the connection information,
the processor is configured to:
generate, when a position of the vehicle specified from the vehicle-road information is within a first area that includes a plurality of intersections, the security rule to include a third communication filtering threshold value specified by the connection information corresponding to the first area, and
generate, when the position of the vehicle specified from the vehicle-road information is within a second area smaller than the first area and including one intersection, the security rule to include a fourth communication filtering threshold value specified by the connection information corresponding to the second area, and
the fourth communication filtering threshold value is larger than the third communication filtering threshold value.

9. The in-vehicle device according to claim 5, wherein:
the out-of-vehicle communication parameter determination information includes the application operation information, and
the processor is configured to, when the out-of-vehicle communication parameter determination information specifies that a plurality of applications are operating in the vehicle,
generate a security rule table relating to each of the plurality of applications that are operating, and
generate the security rule by integrating the plurality of security rule tables.

10. The in-vehicle device according to claim 4, wherein the processor is configured to, when the vehicle-road information does not include the connection information, generate connection information as the out-of-vehicle communication parameter determination information from the vehicle-road information.

11. The in-vehicle device according to claim 1, wherein the security rule includes a restriction relating to at least one of access frequency, communication speed, number of sessions, number of SYN packets, communication address of communication destination, and port number of communication destination that relate to communication by the communication unit.

12. The in-vehicle device according to claim 1, wherein:
the processor is configured to update the security rule,
wherein the processor updates the security rule in response to a new application to be operated in the vehicle or an updated application of an application operating in the vehicle being received by the communication unit.

13. The in-vehicle device according to claim 12, wherein:
a new security rule corresponding to the new application or the updated application is received from the external device, and
the processor is configured to update the security rule, using the new security rule.

14. A server computer comprising:
a processor that is configured to:
generate a security rule for restricting communication of an in-vehicle device configured to be installed in a vehicle with an external device located outside the vehicle, based on vehicle-road information that includes vehicle information of the vehicle and roadside information relating to surroundings of the vehicle; and
transmit the security rule to the in-vehicle device,
wherein the vehicle information includes at least one of application operation information that specifies an application operating in the vehicle and connection information that indicates a communication connection state with the external device.

15. The server computer according to claim 14, wherein the processor is configured to:
receive the vehicle information from the in-vehicle device,
generate the vehicle-road information by adding the vehicle information received to the roadside information;
determine out-of-vehicle communication parameter determination information, based on the vehicle-road information; and
generate the security rule, based on the out-of-vehicle communication parameter determination information.

16. A communication system comprising:
the server computer according to claim 14; and
the in-vehicle device;
wherein the in-vehicle device causes the server computer to communicate, as the external device, with a communication unit installed in the vehicle.

17. A communication system comprising:
the server computer according to claim 15; and
the in-vehicle device;
wherein the in-vehicle device causes the server computer to communicate, as the external device, with a communication unit installed in the vehicle.

18. A control method for an in-vehicle system configured to be installed in a vehicle, the control method comprising:
causing, via an in-vehicle device included in the in-vehicle system, a communication unit that communicates with an external device located outside the vehicle to restrict communication with the external device, in accordance with a security rule generated based on vehicle-road information that includes vehicle information of the vehicle and roadside information which is information relating to surroundings of the vehicle,
wherein the vehicle information includes at least one of application operation information that specifies an application operating in the vehicle and connection information that indicates a communication connection state with the external device.

19. A storage medium that stores a computer program that causes a computer installed in a vehicle to perform the step of:
causing a communication unit that communicates with an external device located outside the vehicle to restrict communication with the external device, in accordance with a security rule generated based on vehicle-road information that includes vehicle information of the vehicle and roadside information which is information relating to surroundings of the vehicle,
wherein the vehicle information includes at least one of application operation information that specifies an application operating in the vehicle and connection information that indicates a communication connection state with the external device.
